(19) United States
(12) Patent Application Publication
(10) Pub. No.: US 2014/0075505 A1
(43) Pub. Date: Mar. 13, 2014

(54) SYSTEM AND METHOD FOR ROUTING SELECTED NETWORK TRAFFIC TO A REMOTE NETWORK SECURITY DEVICE IN A NETWORK ENVIRONMENT

(71) Applicant: Sakthikumar Subramanian, San Jose, CA (US)

(72) Inventor: Sakthikumar Subramanian, San Jose, CA (US)

(73) Assignee: McAfee, Inc.

(21) Appl. No.: 13/610,048

(22) Filed: Sep. 11, 2012

(51) Int. Cl. G06F 21/00

(52) U.S. Cl. 726/3

(57) ABSTRACT

A method provided in one example includes receiving a request for configuration information for a host in a first network, determining whether the request was sent over a quarantine virtual local area network (VLAN) in the first network, and providing to the host a network address of a first domain name system (DNS) server if the request was sent over the quarantine VLAN in the first network. In addition, the first DNS server translates a domain name in a query from the host to a network address of a network security device in a second network. In more specific embodiments, the domain name in the query is mapped to a different network address in a second DNS server. The method may also include providing a network address of the second DNS server if the request was sent over a production virtual local area network (VLAN) in the first network.

### TECHNICAL FIELD

This disclosure relates in general to the field of network security, and more particularly, to routing selected network traffic to a remote network security device in a network environment.

### BACKGROUND

Networking architectures have grown increasingly complex in communication environments. As a networking infrastructure is expanded between a network in a central office and other networks in branch offices of an enterprise, proper routing and network access control become critical. A routing infrastructure is typically configured to enable communication between the branch office networks and the central office network. Network security devices, such as Network Access Control (NAC) appliances, can control access to a network based on network policies. NAC appliances are often deployed in branch office networks of an enterprise to provide endpoint security by preventing unauthorized access to the enterprise's network and controlling access to network nodes in the enterprise's network. NAC appliances can use techniques such as quarantining network traffic, applying policies to an endpoint, and facilitating authentication of users and/or hosts and remediation of noncompliant hosts. The ability to maintain NAC appliances and provide consistency among numerous branch office networks, particularly as an enterprise is scaled, presents a significant challenge to component manufacturers and network operators alike. Furthermore, once NAC appliances have been deployed in branch office networks, changes to centralize or consolidate network access control can result in complicated routing infrastructure changes.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for routing selected network traffic to a remote network security device in a network environment in accordance with one embodiment of the present disclosure;

FIG. 2 is a simplified block diagram illustrating possible example details associated with some elements of the communication system;

FIG. 3 is a simplified interaction diagram illustrating potential operations that may be associated with the communication system;

FIG. 4 is a simplified flowchart illustrating potential operations that may be associated with a Dynamic Host Configuration Protocol (DHCP) server of the communication system;

FIG. 5 is a simplified flowchart illustrating potential operations that may be associated with a wildcard domain name system (DNS) server of the communication system; and

FIG. 6 is a simplified flowchart illustrating potential operations that may be associated with a network security device of the communication system.

### DETAILED DESCRIPTION OF EXAMPLE EMBODIMENTS

### Overview

A method is provided in one example and includes receiving a request for configuration information for a host in a first network. The method also includes determining whether the request was sent over a quarantine virtual local area network (VLAN) in the first network and providing to the host a network address of a first domain name system (DNS) server if the request was sent over the quarantine VLAN in the first network. In addition, the first DNS server translates a domain name in a query from the host to a network address of a network security device in a second network.

In more particular embodiments, the domain name in the query is mapped to a different network address in a second domain name system (DNS) server. The different network address can correspond to a web server in a third network. The method may also include providing a network address of the second DNS server if the request was sent over a production virtual local area network (VLAN) in the first network. Determining whether the request was sent on the quarantine VLAN can include evaluating content in the request. In further embodiments, the network security device sends a command to a layer 2 switch in the first network to move the host from the quarantine VLAN to a production VLAN when the host is authenticated. In yet more detailed embodiments, access control list (ACL) rules are configured on a layer 2 switch connected to the host in the first network. The ACL rules permit network traffic from the quarantine VLAN to be forwarded only if the network traffic is configured with one of hypertext transfer protocol (HTTP), domain name system (DNS) protocol, and dynamic host configuration protocol (DHCP).

### Example Embodiments

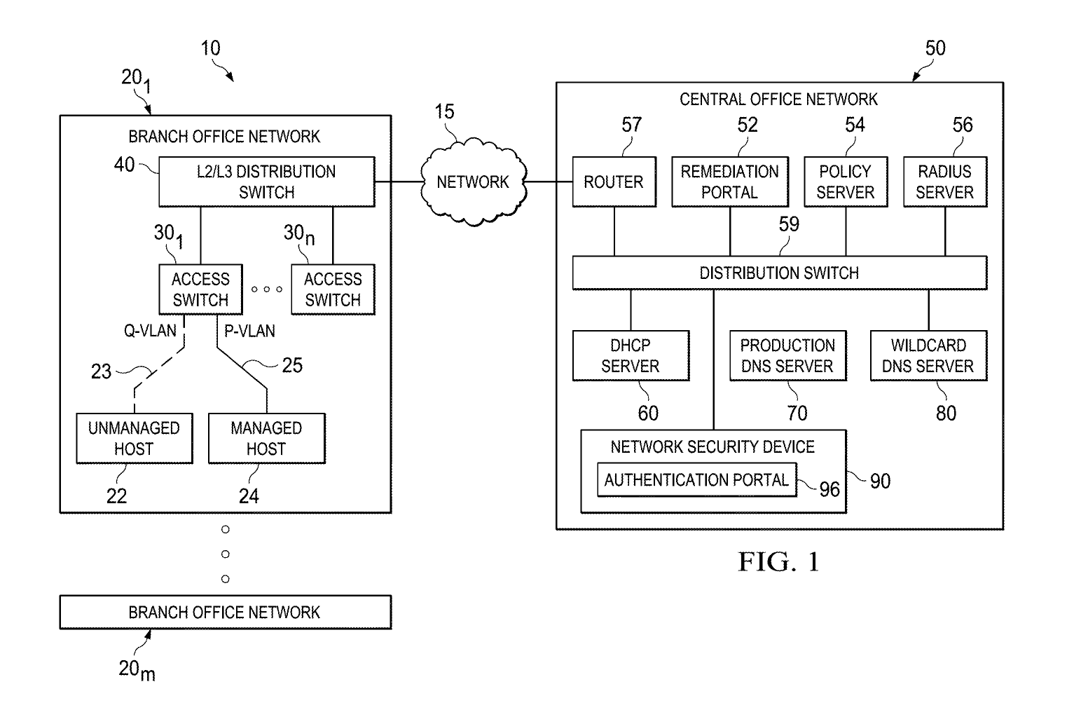

Turning to FIG. 1, FIG. 1 is a simplified block diagram of a communication system 10 for routing selected network traffic to a remote network security device in a network environment. In one example embodiment, communication system 10 achieves the routing with domain name system (DNS) redirection of the network traffic. FIG. 1 includes a central office network 50 and one or more branch office networks 20₁ through 20ₘ. Branch office network 20₁ provides an example configuration of branch office networks 20₁₋ₘ and will be referred to hereinafter as ‘branch office network 20’ for ease of reference. Branch office network 20 includes one or more access switches 30₁ through 30ₙ, an L2/L3 distribution switch 40, an unmanaged host 22, and a managed host 24. Access switch 30₁ provides an example configuration of access switches 30₁₋ₙ and will be referred to hereinafter as ‘access switch 30’ for ease of reference. Managed host 24 communicates with access switch 30 via a production network, such as a production virtual local area network (VLAN) 25, while unmanaged host 22 communicates with access switch 30 via a quarantined network, such as quarantine virtual local area network (VLAN) 23. Unmanaged host 22 may communicate with access switch 30 over quarantine VLAN 23 until host 22 is authenticated and/or remediated according to network policies.

Central office network 50 includes a remediation portal 52, a policy server 54, a Radius server 56, a router 57, a distribution switch 59 (e.g., L2/L3), a Dynamic Host Configuration Protocol (DHCP) server 60, a production domain name system (DNS) server 70, a wildcard DNS server 80, and a network security device 90. The network security device 90 may also include an authentication portal 96. Branch office network 20 and central office network 50 communicate via a network 15 providing connectivity in any suitable form, such as an Intranet or Extranet, a wide area network (WAN), a virtual private network (VPN), a local area network (LAN), a wireless local area network (WLAN), virtual local area network (VLAN), etc., or any suitable combination thereof. In one particular instance, network 15 is configured as a virtual local area network (VLAN), with L2/L3 distribution switch 40 receiving and sending network traffic for branch office network 20 and router 57 receiving and sending network traffic for central office network 50.

Elements of FIG. 1 may be coupled to one another through one or more interfaces employing any suitable connection (wired or wireless), which provides a viable pathway for electronic communications. Additionally, any one or more of these elements of FIG. 1 may be combined or removed from the architecture based on particular configuration needs. Communication system 10 may include a configuration capable of transmission control protocol/Internet protocol (TCP/IP) communications for the electronic transmission or reception of network traffic in a network. Communication system 10 may also operate in conjunction with a user datagram protocol/IP (UDP/IP) or any other suitable protocol, where appropriate and based on particular needs.

For purposes of illustrating certain example techniques of communication system 10, it is important to understand the communications that may be traversing the network. The following foundational information may be viewed as a basis from which the present disclosure may be properly explained.

Network access control (NAC) is a computer networking solution that manages access to a network by endpoint devices (i.e., hosts). A typical NAC appliance is a network security device that can perform authentication and authorization functions for potential users, restrict access to network resources based on defined policies, and implement anti-threat applications such as firewalls, antivirus software, etc. In a typical implementation of a proprietary network, NAC enforcement often requires all network traffic, configured as Hypertext Transfer Protocol (HTTP) messages, from certain hosts to be routed to a local NAC appliance to allow the NAC appliance to take appropriate action based on policies. In one common implementation, a host that attempts to access a network in an airport or hotel may be redirected to a portal to pay for Internet service before being allowed to access the network.

In businesses and other organizations with distributed computer networks, a common configuration can include a central office network (e.g., a data center and/or other centralized network resources) with multiple branch office networks (e.g., networking infrastructure supporting a remote location of an organization). A central office network can be connected to its branch office networks via any suitable type of network (e.g., wide area network (WAN), metropolitan area network (MAN), Intranet, Extranet, VPN, LAN, WLAN, VLAN, etc.) or combination of networks. Accordingly, in some implementations, NAC appliances can be deployed in each branch office network to provide endpoint security in the branch office networks and thereby manage network access attempts locally.

A common branch office implementation for a NAC appliance is a layer 2 (L2) out-of-band network access control (L2 OOBNAC) configuration. ‘Layer 2’ (also referred to as ‘data link layer’) refers to a network communication protocol layer of a multilayered communication model (e.g., Open Systems Interconnection (OSI)) that transfers data between adjacent nodes, for example, in a local area network segment. In the L2 OOBNAC configuration, the NAC appliance is directly connected to trunk ports on an L2/L3 distribution switch, and all traffic from a new and/or quarantined host attempting to access the network is routed to monitoring ports of the NAC appliance using non-routeable quarantine/hold virtual local area networks (VLANs). The NAC appliance is out-of-band because network traffic from a production VLAN (i.e., a VLAN carrying network traffic that is not quarantined and that is permitted to access the production network) bypasses the NAC appliance. Although the data path to the NAC appliance is an L2 network, the NAC appliance bridges network traffic between the quarantine and production networks by switching VLANs via a control path in layer 3 (L3). ‘Layer 3’ (also referred to as ‘network layer’) refers to a network communication protocol layer of a multilayered communication model that is responsible for packet forwarding including routing. The NAC appliance may also act as a firewall between quarantine and production networks (e.g., by applying access control list (ACL) rules in the access switch).

Implementing NAC in each branch office network of a distributed network, however, can have some drawbacks. As an organization grows and its networks are scaled, this approach can require significant overhead to configure and maintain the NAC appliances. Furthermore, deploying a NAC appliance in each branch office can be costly, particularly in large organizations with many geographically dispersed branch offices. In addition, it can be difficult to maintain consistency among the NAC appliances in geographically dispersed branch offices.

In some implementations, an organization may choose to implement network access control in branch office networks with a NAC appliance located in a corresponding central office network. Typically, the branch office networks are separated from the central office network by one or more intermediate routers configured with routing tables to provide paths for network traffic from hosts in the branch office networks to reach the central office network and vice versa. Thus, access switches and L2/L3 distribution switches in the branch office networks are generally connected to the NAC appliance in the central office via an L3 network. Consequently, network traffic from a host (e.g., personal computer, laptop, tablet, smartphone, etc.) attempting to access a branch office network, needs to be routed to the NAC appliance in the central office, so that the NAC appliance can provide appropriate network access based on a configured security policy. Routing selected network traffic from particular hosts (e.g., new and/or quarantined hosts) to a particular network address, such as an Internet Protocol (IP) address of the NAC appliance in the central office may require complicated changes to the routing infrastructure or explicit network addresses to be provided to users in advance in order to route network traffic to the NAC appliance. A solution is needed that redirects network traffic to a remote network security device (e.g., NAC appliance in a central office network) without requiring complicated changes to the routing infrastructure and without the need for an explicit network address of the security device to be provided to users in advance.

In accordance with one example implementation, communication system 10 can resolve the aforementioned issues associated with deficient approaches to routing selected network traffic to an out-of-band network security device in a remote network. More specifically, communication system 10 uses domain name system (DNS) redirection and access control lists (ACLs) to provide out-of-band network access control to branch office networks of a proprietary network environment. An unmanaged host in a branch office network can be firewalled (also referred to herein as ‘quarantined’) on ports of an access switch by configuring access control list (ACL) rules of the access switch. Selected network traffic, such as HTTP traffic, from the quarantined host can be routed to the network security device in a central office network by configuring a Dynamic Host Configuration Protocol (DHCP) server to provide a network address of a wildcard DNS server to the quarantined, unmanaged host. The wildcard DNS server resolves all domain name queries to the network address (e.g., IP address) of the out-of-band network security device in the central office network. The ACL rules of the access switch can be configured to permit selected network traffic from the quarantined host to be forwarded to the DHCP and wildcard DNS server(s) and to the network security device in the central office, and to block any other traffic from the quarantined host. Consequently, communication system 10 ensures that the DHCP server, the wildcard DNS server, and the out-of-band network security device are reachable from the quarantine network. Once the host is authenticated and/or remediated in accordance with network policies, the network security device can configure ACL rules on the access switch to move a port of the quarantine VLAN to a production VLAN, thereby achieving per switch port security.

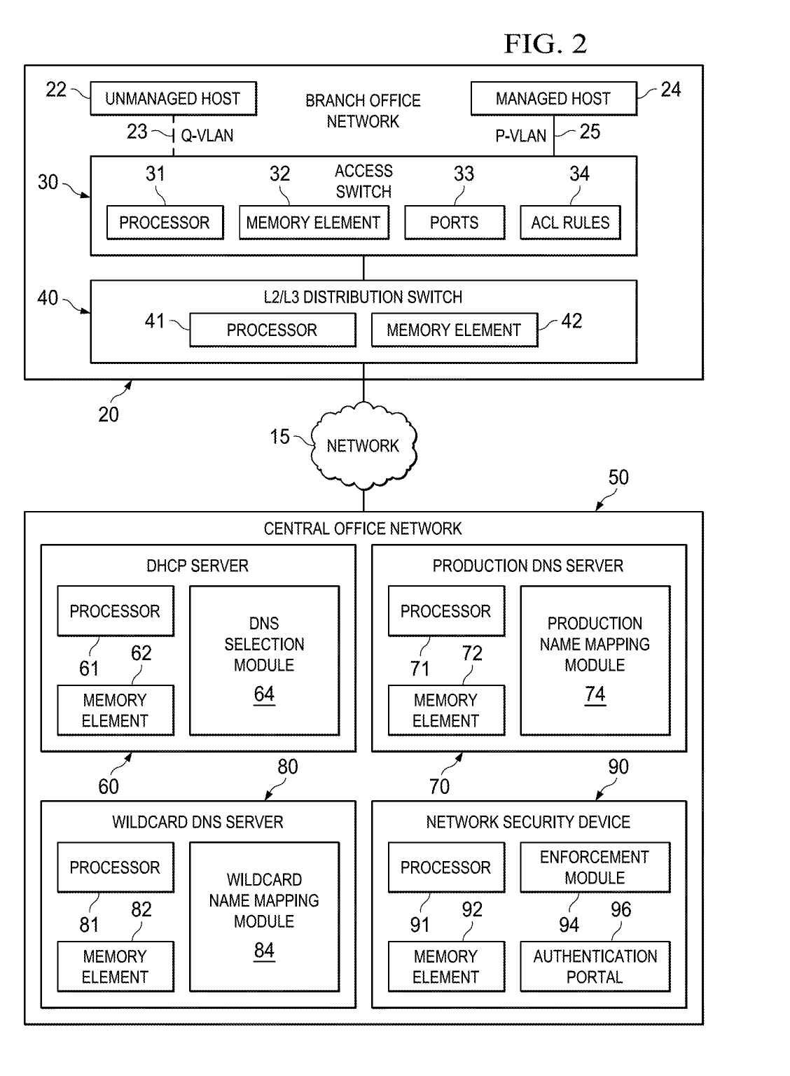

Turning to FIG. 2, FIG. 2 is a simplified block diagram illustrating one possible set of details associated with communication system 10. Each of the elements in branch office network 20 and central office network 50 of communication system 10 can include a processor and a memory element. For example, in branch office network 20, access switch 30 includes a processor 31 and a memory element 32, and L2/L3 distribution switch 40 includes a processor 41 and a memory element 42. In central office network 50, DHCP server 60 includes a processor 61 and a memory element 62, production DNS server 70 includes a processor 71 and a memory element 72, wildcard DNS server 80 includes a processor 81 and a memory element 82, and network security device 90 includes a processor 91 and a memory element 92.

Other modules and components may also be provided in the elements of communication system 10 to support routing selected network traffic from unmanaged host 22 to out-of-band network security device 90. Access switch 30 can include ports 33 (both quarantined and production) and ACL rules 34, DHCP server 60 can include a DNS selection module 64, and wildcard DNS server 80 can include a wildcard name mapping module 84. Additionally, network security device 90 can include an enforcement module 94 and authentication portal 96, and production DNS server 70 can include a production name mapping module 74. Before discussing potential flows associated with the architectures of FIG. 1-2, a brief discussion is provided about some of the possible infrastructure that may be included in communication system 10.

Generally, this disclosure may be implemented in any suitable type or topology of network (e.g., Intranet, Extranet, LAN, WAN, WLAN, MAN, VLAN, VPN, etc.) or suitable combinations thereof, including wired and/or wireless communication, in which network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., TCP/IP). The term ‘data’ as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

Hosts 22 and 24 may be associated with employees, clients, customers, or other end users attempting to access communication system 10. The term ‘host’ is inclusive of devices used to initiate a communication, such as a personal computer, a laptop, a smart phone, a tablet, or any other device, component, element, or object capable of initiating voice, audio, video, media, or data exchanges within communication system 10. Hosts 22 and 24 may also be inclusive of a suitable interface for a human user, such as a display, a keyboard, a touchpad, a remote control, or other terminal equipment. Hosts 22 and 24 may also include any device that seeks to initiate a communication on behalf of another entity or element, such as a program, a database, or any other component, device, element, or object capable of initiating an exchange within communication system 10.

Unmanaged host 22 may be distinguished from managed host 24 in that unmanaged host 22 represents a host that is not yet authorized to access communication system 10. For example, host 22 may not be authenticated to communication system 10, may not have authentication credentials, may need remediation in accordance with network policies of communication system 10, and/or may not include a guest client portal for accessing communication system 10. Consequently, unmanaged host 22 communicates with access switch 30 via quarantine VLAN 23 in which access to network resources is restricted. Managed host 24, however, represents a host that has been authorized to access communication system 10 and, therefore, communicates with access switch 30 via production VLAN 25 in which network traffic from host 24 is permitted in accordance with network policies. Examples of unmanaged hosts 22 could include customers, clients, or vendors attempting to access communication system 10 (e.g., plugging a laptop into a jack in the wall of a conference room where the jack is connected to an access switch of branch office network 20, a laptop connecting to a wireless access point (WAP) of branch office network 20).

Hosts 22 and 24 may also include software (e.g., clients) that enables communication in networks 20 and 50 according to various protocols. For example, hosts 22 and 24 could each include a dynamic host configuration protocol (DHCP) client and a domain name system (DNS) client to permit communication with DHCP server 60 and DNS servers 70 and 80, respectively.

Access switch 30, L2/L3 distribution switch 40, router 57, distribution switch 59, remediation portal 52, policy server 54, Radius server 56, DHCP server 60, production DNS server 70, wildcard DNS server 80, and network security device 90 are network elements that facilitate electronic communication with hosts and/or other sources in a given network (e.g., branch office networks 20₁₋ₘ, central office network 50, the Internet, etc.). As used herein, the term ‘network element’ is meant to encompass routers, switches, wireless access points (WAPs), gateways, bridges, loadbalancers, appliances, firewalls, servers, processors, modules, or any other suitable device, component, element, proprietary appliance, or object operable to exchange information in a network environment. A network element may include any suitable hardware, software, components, modules, interfaces, or objects that facilitate the operations thereof. This may be inclusive of appropriate algorithms and communication protocols that allow for the effective exchange of data or information.

In one implementation, the network elements of branch office network 20 and central office network 50 include software to achieve (or to foster) the routing of selected network traffic to an out-of-band network security device in a remote network, as outlined herein in this Specification. Note that in one example, each of these elements can have an internal structure (e.g., a processor, a memory element, etc.) to facilitate some of the operations described herein. In other embodiments, these routing activities may be executed externally to these elements, or included in some other network element to achieve this intended functionality. Alternatively, the elements in branch office network 20 and/or central office network 50 may include this software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof.

In operational terms, layer 3 (L3) concepts are used to accomplish the routing of selected network traffic from a quarantine VLAN to an out-of-band network security device in a remote network. More specifically, DNS redirection is used to route HTTP traffic from unmanaged host 22, which is connected to quarantine VLAN 23 in branch office network 20, to out-of-band network security device 90 in central office network 50. Data path traffic, such as the HTTP traffic, is directed to network security device 90 via an L3 network (e.g., network 15) whenever network security device 90 needs to receive the traffic. For example, network security device 90 may need to receive HTTP traffic when it originates from a particular source (e.g., unmanaged host 22) that does not have proper credentials or needs remediation.

Hosts such as hosts 22 and 24 can attempt to access branch office network 20 through access switch 30. Access switch 30 may be a layer 2 (L2) switch with some of ports 33 segregated for quarantine VLANs and others segregated for production VLANs. Quarantine VLANs are networks that restrict network traffic from accessing network resources (e.g., in central office network 50, in branch office network 20, in public networks such as the Internet, etc.), based on policies. When unmanaged host 22 initially connects to access switch 30, the host is moved to quarantine VLAN 23 and its network traffic is firewalled. This can be accomplished by configuring ACL rules 34 on switch ports 33 of access switch 30 via an 802.1x RADIUS response from Radius server 56 to access switch 30. Access switch 30 can use layer 2 addresses (e.g., Media Access Control (MAC) addresses) of hosts 22 and 24 to direct network traffic to the appropriate quarantine or production ports. Accordingly, network traffic associated with unmanaged host 22 is segregated into its designated quarantine VLAN 23 and cannot access production VLAN 25. Additionally, users may specify ACL rules in addition to VLANs for quarantine and production ports per access switch. Thus, quarantine VLANs and/or quarantine ACL rules, and production VLANs and/or production ACL rules may be configured on access switch 30.

In branch office network 20, a layer 3 (L3) out-of-band network access control configuration can be implemented with at least two VLANs: quarantine VLAN 23 and production VLAN 25. In one scenario, network 15 can be configured as another VLAN, between L2/L3 distribution switch 40 and central office network 50. The VLANs can be routable and each one can be configured with an IP address and a mask. By way of illustration, IP addresses could be configured from 1.1.1.0/24 for production VLAN 25, 2.2.2.0/24 for quarantine VLAN 23, and 3.3.3.0/24 for the VLAN of network 15. One or more VLANs could also be configured in central office network 50, and one example VLAN could have IP addresses configured from 4.4.4.0/24.

L2/L3 distribution switch 40 can function as an L2 switch with L3 routing capabilities, in which it can communicate with access switch 30 (layer 2) and can route packets to central office network 50 over network 15 (layer 3). In some embodiments, access switch 30 and L2/L3 distribution switch 40 can be combined into a single switch with routing capabilities.

It will be apparent that other suitable network elements can be provisioned in the network and provide the desired functionalities. For example, a router could be provisioned instead of an L2/L3 distribution switch. In another example configuration, branch office network 20 may use one or more wireless access points (WAPs), which serve as access switches 30 in communication system 10. In such configurations, hosts 22 and 24 can attempt to access branch office network 20 through a WAP. A quarantine VLAN and a production VLAN can be defined on wired switches and mapped to specific service set identifiers (SSIDs) on the WAP. These SSIDs can be mapped to hosts 22 and 24 for membership in an appropriate VLAN (production or quarantine). Thus, it will be apparent that references herein to the functionalities of access switch 30, can also be applied to a wireless access point to achieve the operational objectives of communication system 10.

In central office network 50, router 57 and distribution switch 59 represent one possible implementation to provide routing and switching operations for network traffic in central office network 50. Router 57 could be a network element such as, for example, an L3 router providing routing of network traffic between central office network 50 and other networks such as branch office network 20. Distribution switch 59 could be a network element such as an L2/L3 distribution switch to provide reception and transmission of packets between elements in central office network 50.

Dynamic Host Configuration Protocol (DHCP) is a network protocol that can be implemented by a network element, such as DHCP server 60, to configure hosts to communicate in a network environment. DHCP server 60 can acquire configuration information for a host (e.g., host 22 or 24) that may include an IP address for the host, an IP address for a domain name system (DNS) server, and/or routing information. This configuration information can be used to configure the host to enable IP communications in communication system 10. For a DHCP request from a host on production VLAN 25, DNS selection module 64 of DHCP server 60 can provide the network address of production DNS server 70 to the host. For a DHCP request from a host on quarantine VLAN 23, however, DNS selection module 64 of DHCP server 60 can provide the network address of wildcard DNS server 80 to the host.

In some embodiments, DHCP server 60 could run in a central office network such as central office network 50 and could serve both quarantine and production networks. In other embodiments, DHCP server 60 could run on an L2/L3 distribution switch in a branch office network. For example, DHCP server 60 could run on L2/L3 distribution switch 40 serving the VLANs of branch office network 20 (e.g., quarantine VLAN 23, production VLAN 25, the VLAN of network 15).

Generally, a DNS server can respond to queries against a directory server and translate a domain name (i.e., an identification string that represents an Internet Protocol resource or service such as a web site) into a numeric IP address. Production DNS server 70 can be a network element, such as a server, and production name mapping module 74 translates domain names to their proper network addresses. Wildcard DNS server 80 can also be a network element, such as a server, and wildcard name mapping module 84 translates any domain name in a DNS query to the network address of network security device 90. Wildcard DNS server 80 may be an additional DNS server to which only quarantined network traffic is routed, due to the configuration of DNS selection module 64 of DHCP server 60. In some embodiments, production DNS server 70 and/or wildcard DNS server 80 may be integrated with DHCP server 60.

The configuration of DHCP server 60, enables DNS queries from an unmanaged host in a quarantine VLAN to be routed to wildcard DNS server 80. Consequently, when a browser is opened on unmanaged host 22, a DNS query is routed to wildcard DNS server 80, and wildcard name mapping module 84 translates the domain name in the query into the network address of network security device 90. Any subsequent HTTP traffic from unmanaged host 22 is redirected to the out-of-band network security device 90. Thus, DNS redirection is used to enable selected network traffic, such as HTTP messages, from a quarantine VLAN to be routed to an out-of-band network security device in another network, using a layer 3 network and without making changes to the routing infrastructure.

In one embodiment authentication, authorization and accounting (AAA) can be provided in central office network 50 of communication system 10. AAA can be provided by Radius server 56, using the Remote Authentication Dial in User Service (RADIUS) networking protocol to authenticate users or devices to the network, to authorize users or devices for certain network resources, and to account for usage of the network resources. When a host (e.g., managed host 24) is connected to access switch 30, it can be moved to a production VLAN if specified by policy, with the port being opened by RADIUS. If a host does not have a supplicant (i.e., a client that seeks to be authenticated), then the port can be moved to a quarantine VLAN (e.g., quarantine VLAN 23) and debounced after setting up appropriate ACL rules 34. The appropriate ACL rules 34 can be configured via RADIUS on switch ports 33 to firewall network traffic from quarantined hosts (e.g., host 22).

Network security device 90 can be a network element (e.g., a NAC appliance) and can be configured to control access to communication system 10 by unmanaged hosts based on policies. A single port of network security device 90 can be configured in an L3 out-of-band network access control mode, which can prevent bridging of network traffic received on the port. Redirection of host 22 to authentication portal 96 (e.g., Secure Guest Access Portal (SGAP)) and/or remediation portal 52 can be achieved using the IP address of the unmanaged host 22. Network security device 90 may also query a network access control (NAC) server (not shown) to maintain host state. Querying the NAC server with the IP address of unmanaged host 22 enables the NAC server to determine the state of the host (e.g., healthy, unhealthy, managed/unmanaged). The NAC server may also be queried using the MAC address received via RADIUS.

Additionally, a management network (not shown) can connect a management port of access switch 30 and a management port of network security device 90 to provide a control path to access switch 30. The management network allows management traffic to be communicated from network security device 90 to access switch 30. Management traffic can include commands to move a quarantine VLAN port to a production VLAN (or vice-versa), for example, if authentication and/or remediation of the corresponding unmanaged host is successful. Although the management port of network security device 90 is typically connected to a different switch to avoid mixing management port traffic and monitoring port traffic, in some implementations the management port of network security device 90 could be connected to distribution switch 59. In this case, the management traffic and data traffic may be segregated into different VLANs.

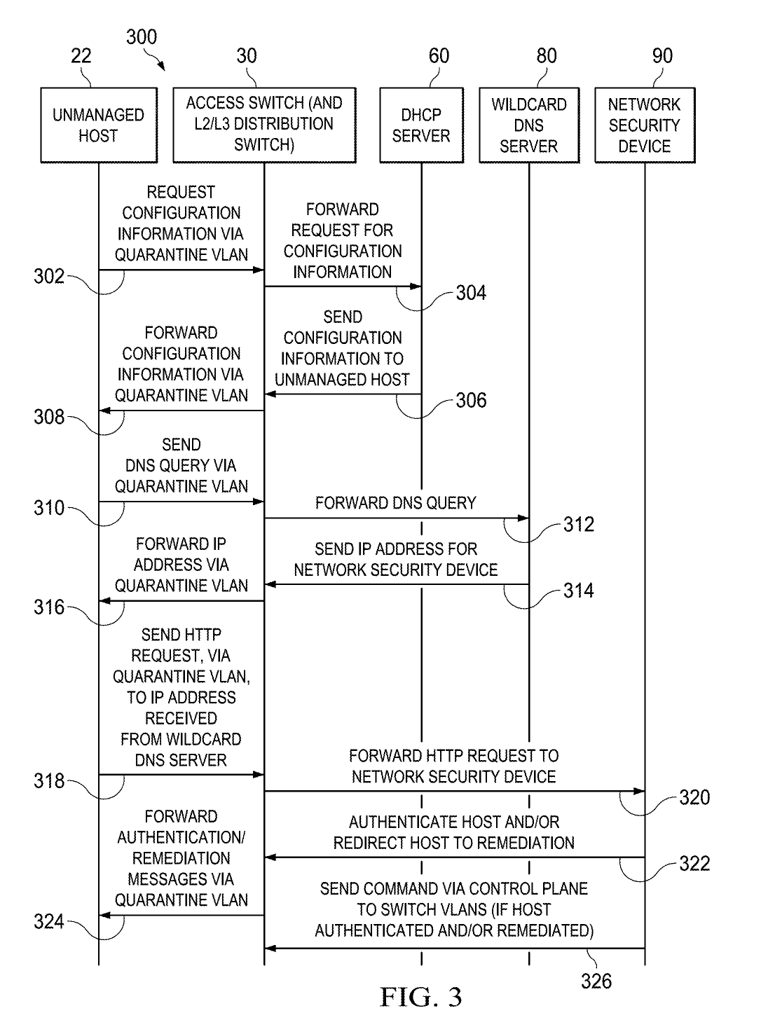

Turning to FIG. 3, a simplified interaction diagram 300 illustrates potential message flows between elements of communication system 10, when selected network traffic is routed to a remote out-of-band network security device. FIG. 3 involves elements of branch office network 20 including unmanaged host 22 and access switch 30. FIG. 3 also involves elements that may be in central office network 50 including DHCP server 60, wildcard DNS server 80, and network security device 90. For simplicity, access switch 30 is shown in combination with L2/L3 distribution switch 40, which is one possible implementation as previously described herein. Additionally, other network elements such as routers, switches, etc., and combinations thereof, may be configured in branch office network 20 and/or central office network 50, but are not shown in FIG. 3 for simplicity.

Prior to the interaction flows shown in FIG. 3, certain communications may occur when unmanaged host 22 initially attempts to access branch office network 20, for example, by connecting to access switch 30. In an example scenario, a contractor at a branch office facility may plug-in a laptop (e.g., host 22) in a conference room that connects directly to an access switch (e.g., access switch 30) of the branch office facility's network (e.g., branch office network 20). Access switch 30 can use the Institute of Electrical and Electronics Engineers (IEEE) 802.1x protocol on the management network to acquire credentials and attempt to authenticate host 22. More specifically, if host 22 has a supplicant to provide its credentials (e.g., username and password), then access switch 30 can request and receive credentials from host 22 using the 802.1x protocol and can send the credentials to network security device 90 via the management network. If host 22 does not have a supplicant to provide its credentials, then 802.1x may time out and access switch 30 can attempt to authenticate a MAC address of host 22.

Network security device 90 can communicate with Radius server 56 to determine whether the credentials of host 22 should be authenticated. If the credentials are unknown, or if there is no supplicant on host 22, then network security device 90 can move host 22 to quarantine VLAN 23 via an 802.1x RADIUS response to access switch 30. This can be accomplished via the management network in which network security device 90 sends commands to access switch 30 over L3 network 15. These commands can configure ACL rules 34 on switch ports 33 of access switch 30 in order to firewall the network traffic from host 22. Additionally, ACL rules 34 of access switch 30 can be configured (e.g., by a user) to allow certain network traffic from quarantine VLAN 23 to be forwarded to central office network 50, to thereby enable the routing of HTTP network traffic from unmanaged host 22 to network security device 90. Such traffic could include DHCP requests to DHCP server 60, DNS queries to wildcard DNS server 80, and HTTP traffic to network security device 90.

With reference to FIG. 3, at 302, unmanaged host 22 sends a DHCP request, via quarantine VLAN 23 and access switch 30, to DHCP server 60 for configuration information for unmanaged host 22. Configuration information can include a network address (e.g., IP address) for unmanaged host 22 and a network address of a DNS server to translate domain names to network addresses. Additionally, a default route (or packet forwarding rule) may also be part of the configuration information. The DHCP request from unmanaged host 22 may be a layer 2 message sent over quarantine VLAN 23, and received by access switch 30. ACL rules 34 can permit DHCP requests from quarantine VLAN 23 to DHCP server 60 and therefore, access switch 30 could forward the DHCP request to L2/L3 distribution switch 40.

At 304, the request for configuration information is forwarded to DHCP server 60. If DHCP server 60 is provisioned in branch office network 20, then it may run on L2/L3 distribution switch 40 and receive the request via layer 2. If DHCP server 60 is provisioned in remote central office network 50, however, an application programming interface (API), such as an IP helper, may be implemented on L2/L3 distribution switch 40 to facilitate the remote communication to DHCP server 60.

When DHCP server 60 receives the request, it determines whether the request was sent over a quarantine VLAN. This determination may be accomplished by examining the contents of the request. For example, the request may be in the form of a packet with a header and a payload. VLAN tagging can be used in which a VLAN identifier (ID) is inserted into the packet header to identify the VLAN to which the packet belongs. Accordingly, the packet header can be examined to determine whether the request belongs to a quarantine VLAN such as quarantine VLAN 23. If it is determined that the request belongs to quarantine VLAN 23, DNS selection module 64 selects the network address of wildcard DNS server 80. At 306, DHCP server 60 sends the configuration information to unmanaged host 22 via access switch 30. The configuration information can include a network address for host 22 and the network address of wildcard DNS server 80. At 308, access switch 30 forwards the configuration information to host 22 via quarantine VLAN 23.

Once unmanaged host 22 has been configured by DHCP server 60, a web browser on unmanaged host 22 may be opened, and a domain name may be selected for a desired web server (e.g., hardware or software IP resource that delivers web pages within a private network or through the Internet). The domain name may be entered in the web browser as part of a uniform resource locator (URL). By way of example, a domain name of a desired web server can be selected when the browser selects a default home page, when a user enters a URL in a browser interface, or when the user clicks on a hyperlink.

At 310, unmanaged host 22 sends a DNS query to wildcard DNS server 80 to obtain a network address for the selected domain name. Wildcard DNS server 80 can translate the domain name in the DNS query into an IP address. In 310, the DNS query from unmanaged host 22 may be a layer 2 message sent over quarantine VLAN 23, and received by access switch 30. ACL rules 34 can be configured to permit DNS queries from quarantine VLAN 23 to wildcard DNS server 80. Accordingly, access switch 30 could forward the DNS query to L2/L3 distribution switch 40 and, at 312, the DNS query is routed to wildcard DNS server 80 over L3 network 15.

Wildcard DNS server 80 can be configured to resolve any domain name of a DNS query to the network address of network security device 90. For example, a domain name of www.XYZCompany.com can have a unique network address in production DNS server 70, which is not equivalent to, and not otherwise associated with, the network address of network security device 90. Nevertheless, if www.XYZCompany.com is provided in a DNS query to wildcard DNS server 80, then wildcard name mapping module 84 translates www.XYZCompany.com to the network address of network security device 90. Consequently, regardless of which web server is desired and requested by unmanaged host 22, host 22 receives the network address of network security device 90. Thus, at 314, wildcard DNS server 80 sends the network address of network security device 90 to unmanaged host 22 via access switch 30. At 316, access switch 30 forwards the network address of network security device 90 to unmanaged host 22.

At 318, the browser of unmanaged host 22 sends an HTTP request, via quarantine VLAN 23 and access switch 30, to the IP address received from wildcard DNS server 80. The request from unmanaged host 22 may be a layer 2 message sent over quarantine VLAN 23, and received by access switch 30. ACL rules 34 can be configured to permit HTTP traffic from a quarantine VLAN to wildcard DNS server 80. Accordingly, access switch 30 could forward the HTTP request to L2/L3 distribution switch 40 and, at 320, the HTTP request is routed to network security device 90 over L3 network 15.

Network security device 90 can perform appropriate authentication and/or remediation activities, based on policies, which may be provided by policy server 54. Network security device 90 can direct unmanaged host 22 to remediation portal 52 by sending, at 322, a network address of remediation portal to unmanaged host 22 via access switch 30. At 324, the message can be forwarded from access switch 30 to host 22. Host 22 may then communicate with remediation portal 52 to be remediated or to otherwise be brought into compliance with policies.

If host 22 is remediated by remediation portal 52, then host 22 can open its browser again and, at 310 and 312, send a new DNS query to wildcard DNS server 80. Wildcard DNS server 80 can again, at 314 and 316, send the IP address of network security device 90 to unmanaged host 22. Host 22 can send, at 318 and 320, an HTTP request to the received network address (of network security device 90).

If remediation has been performed, or if remediation is not required, then network security device 90 can authenticate the user/host 22 using authentication portal 96, which could be configured as a Secure Guest Access Portal (SGAP). Network security device 90 can direct unmanaged host 22 to authentication portal 96 by sending, at 322, a network address of authentication portal 96 to unmanaged host 22 via access switch 30. At 324, the message can be forwarded from access switch 30 to unmanaged host 22. Host 22 may then communicate with authentication portal 96 to provide authentication credentials and any other appropriate information.

Once host 22 has been authenticated and remediation is not required (or has already been performed), at 326, network security device 90 can send commands to access switch 30 to switch unmanaged host 22 from quarantine VLAN 23 to a production VLAN, such as production VLAN 25. The commands can configure ACL rules 34 for switch ports 33, and can be sent over the management network (also referred to as the control plane). Once host 22 switches to production VLAN 25, another DHCP request is sent to DHCP server 60 for new configuration information. DHCP server 60 can then determine that the request was not received from a quarantine VLAN, and can provide a new network address for host 22. DHCP server can also provide the network address of production DNS server 70, which resolves domain name queries to their actual network addresses. Thus, any subsequent HTTP requests from host 22 can be directed to the desired web server by production DNS server 70.

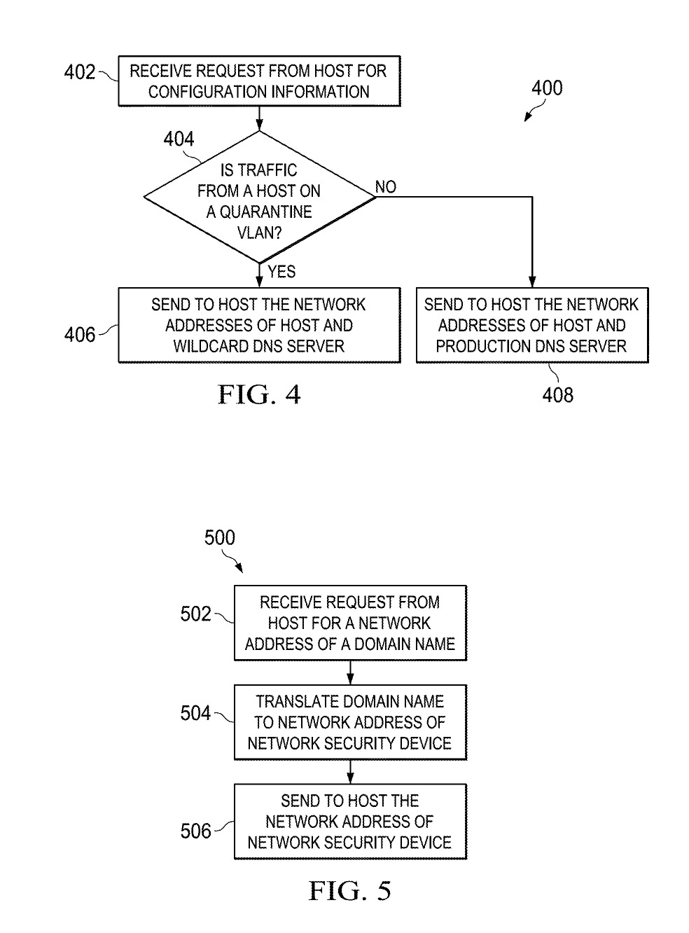

Turning to FIG. 4, a flowchart illustrates a flow 400 of potential operations that may be associated with DHCP server 60 in accordance with the present disclosure. At 402, DHCP server 60 receives a request from a host (e.g., unmanaged host 22 or managed host 24) for configuration information. At 404, a determination is made as to whether the host associated with the request belongs to a quarantine VLAN. In one example implementation, the request is a packet with a header and a payload. The header is examined to determine whether it is tagged with a VLAN ID that indicates the packet was sent on a quarantine VLAN such as quarantine VLAN 23. If it is determined that the packet was sent on a quarantine VLAN, then at 406, DHCP server 60 sends IP addresses for the unmanaged host that sent the DHCP request and for wildcard DNS server 80. If it is determined that the packet was not sent on a quarantine VLAN, however, then at 408, DHCP server 60 sends IP addresses for the managed host that sent the DHCP request and for production DNS server 70.

Turning to FIG. 5, a flowchart illustrates a flow 500 of potential operations that may be associated with wildcard DNS server 80 in accordance with the present disclosure. At 502, wildcard DNS server 80 receives a request (i.e., a DNS query) from a host to translate a domain name of a desired web server into a network address. In one example embodiment, in wildcard DNS server 80, all domain names map to the same network address, which is the network address for network security device 90. Additionally, network security device 90 is in a remote network (e.g., central office network 50) relative to the host that sent the request. Thus, at 504, wildcard name mapping module 84 translates the domain name in the request to the network address of network security device 90. At 506, wildcard DNS server 80 sends the translated domain name to the host.

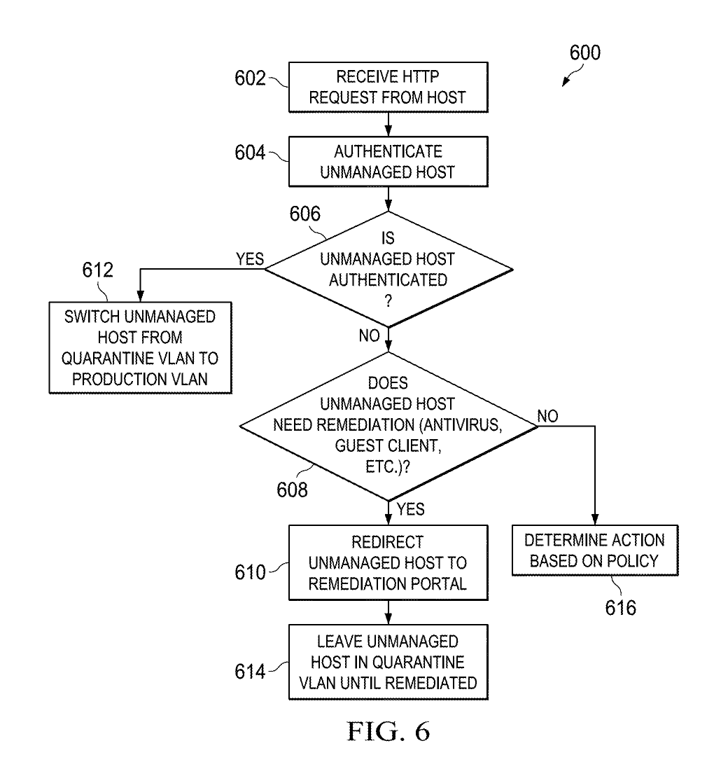

Turning to FIG. 6, a flowchart illustrates a flow 600 of potential operations that may be associated with network security device 90 in accordance with the present disclosure. At 602, network security device 90 receives an HTTP request from unmanaged host 22 on quarantine VLAN 23. Depending on the policies of central office network 50, at 604, network security device 90 may attempt to authenticate host 22. For example, host 22 can be directed to authentication portal 96, which can be used to prompt a user of unmanaged host 22 to enter a username and password. At 606, a determination is made as to whether unmanaged host 22 is authenticated. If it is determined that host 22 is authenticated, then at 612, network security device 90 can send commands to access switch 30 to switch unmanaged host 22 from quarantine VLAN 23 to a production VLAN, such as production VLAN 25. The commands can configure ACL rules 34 for switch ports 33 of access switch 30, and can be sent over the management network.

If the user is not authenticated as determined at 606, then at 608, a determination is made as to whether unmanaged host 22 needs remediation. For instance, unmanaged host may need one or more software patches, a guest client for accessing communication system 10, or an antivirus scan. If it is determined that unmanaged host 22 needs remediation, then at 610, host 22 can be redirected to remediation portal 52, where remediation can be performed (e.g., software patches downloaded, virus scans run, guest client installed, etc.). As indicated at 614, unmanaged host 22 is left in quarantine VLAN 23 until host 22 is successfully remediated. Once remediation is successful, however, host 22 may send another HTTP request to network security device 90 and flow may pass back to 602, to authenticate host 22 and potentially switch host 22 to production VLAN 25 if the authentication is successful. If it is determined at 608, that unmanaged host 22 does not need remediation, then policy may determine whether unmanaged host 22 (not authenticated, but not in need of remediation) remains in quarantine VLAN 23 or is moved to a production VLAN such as production VLAN 25.

Note that in certain example implementations, the routing functions outlined herein may be implemented by logic encoded in one or more tangible, non-transitory media (e.g., embedded logic provided in an application specific integrated circuit (ASIC), digital signal processor (DSP) instructions, software (potentially inclusive of object code and source code) to be executed by a processor, or other similar machine, etc.). In some of these instances, one or more memory elements (as shown in FIG. 2) can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, a processor (as shown in FIG. 2) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

In one example implementation, network elements of branch office network 20 and central office network 50 may include software in order to achieve the routing functions outlined herein. These activities can be facilitated by various modules (e.g., DNS selection module 64, wildcard name mapping module 84, enforcement module 94), which can be suitably combined in any appropriate manner, and which may be based on particular configuration and/or provisioning needs. Additionally, these network elements may include a processor that can execute software or an algorithm to perform the routing operations, as disclosed in this Specification. These network elements may further keep information, to be used in achieving the routing activities as discussed herein, in any suitable memory element (random access memory (RAM), ROM, EPROM, EEPROM, ASIC, etc.), software, hardware, or in any other suitable component, device, element, or object where appropriate and based on particular needs. Any of the memory items discussed herein (e.g., databases, tables, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 10 and its teachings are readily scalable and can accommodate a large number of components, as well as more complicated/sophisticated arrangements and configurations. Accordingly, the examples provided should not limit the scope or inhibit the broad teachings of communication system 10 as potentially applied to a myriad of other architectures.

It is also important to note that the steps in the preceding flow diagrams illustrate only some of the possible routing and redirection scenarios and patterns that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. For example, although the present disclosure has been described with reference to particular communication exchanges involving certain endpoint components and certain protocols (e.g., HTTP, DHCP, DNS, IP, etc.), communication system 10 may be applicable to other protocols and arrangements. Moreover, certain components may be combined, separated, eliminated, or added based on particular needs and implementations. For example, access switch 30 may be combined with L2/L3 distribution switch 40, DHCP server 60 may be combined with a switch (e.g., L2/L3 distribution switch 40) and provisioned in branch office network 20, DHCP server 60 and production DNS server 70 may be integrated, wildcard DNS server 80 may be integrated with DHCP server 60 and/or production DNS server 70, a wireless access point (WAP) may be used instead of (or in addition to) access switch 30, etc. Additionally, although communication system 10 has been illustrated with reference to particular elements and operations that facilitate the communication process, these elements and operations may be replaced by any suitable architecture, protocols, and/or processes that achieve the intended functionality of communication system 10.

What is claimed is:

1. A method, comprising:
receiving a request for configuration information for a host in a first network;
determining whether the request was sent over a quarantine virtual local area network (VLAN) in the first network; and
providing to the host a network address of a first domain name system (DNS) server if the request was sent over the quarantine VLAN in the first network,
wherein the first DNS server translates a domain name in a query from the host to a network address of a network security device in a second network.

2. The method of claim 1, wherein the domain name in the query is mapped to a different network address in a second domain name system (DNS) server.

3. The method of claim 2, further comprising:
providing a network address of the second DNS server if the request was sent over a production virtual local area network (VLAN) in the first network.

4. The method of claim 2, wherein the different network address corresponds to a web server in a third network.

5. The method of claim 1, wherein the determining whether the request was sent on the quarantine VLAN includes evaluating content in the request.

6. The method of claim 1, wherein the request is routed between the first and second networks using layer 3 of a network communication protocol.

7. The method of claim 1, wherein the network security device sends a command to a layer 2 switch in the first network to move the host from the quarantine VLAN to a production VLAN when the host is authenticated.

8. The method of claim 7, wherein the command is operable to configure an access control list (ACL) rule to change a port on the layer 2 switch.

9. The method of claim 1, wherein one or more access control list (ACL) rules are configured on a layer 2 switch connected to the host in the first network, wherein the one or more ACL rules permit network traffic from the quarantine VLAN to be forwarded only if the network traffic is configured with one of hypertext transfer protocol (HTTP), domain name system (DNS) protocol, and dynamic host configuration protocol (DHCP).

10. The method of claim 1, wherein the network security device is out-of-band.

11. Logic encoded in one or more non-transitory computer-readable media that includes code for execution and when executed by a processor is operable to perform operations comprising:
receiving a request for configuration information for a host in a first network;
determining whether the request was sent over a quarantine virtual local area network (VLAN) in the first network; and
providing to the host a network address of a first domain name system (DNS) server if the request was sent over the quarantine VLAN in the first network,
wherein the first DNS server translates a domain name in a query from the host to a network address of a network security device in a second network.

12. The logic of claim 11, wherein the domain name in the query is mapped to a different network address in a second domain name system (DNS) server.

13. The logic of claim 12, wherein the processor is operable to perform further operations comprising: providing a network address of the second DNS server if the request was sent over a production virtual local area network (VLAN) in the first network.

14. The logic of claim 11, wherein one or more access control list (ACL) rules are configured on a layer 2 switch connected to the host in the first network, wherein the one or more ACL rules permit network traffic from the quarantine VLAN to be forwarded only if the network traffic is configured with one of hypertext transfer protocol (HTTP), domain name system (DNS) protocol, and dynamic host configuration protocol (DHCP).

15. An apparatus, comprising:
a memory element configured to data;
a processor operable to execute instructions associated with the data; and
a server selection module configured to interface with the memory element and the processor, wherein the apparatus is configured to:
receive a request for configuration information for a host in a first network;
determine whether the request was sent over a quarantine virtual local area network (VLAN) in the first network; and
provide to the host a network address of a first domain name system (DNS) server if the request was sent over the quarantine VLAN in the first network, wherein the first DNS server is configured to translate a domain name in a query from the host to a network address of a network security device in a second network.

16. The apparatus of claim 14, wherein the domain name in the query is mapped to a different network address in a second domain name system (DNS) server.

17. The apparatus of claim 16, wherein the apparatus is further configured to:
provide a network address of the second DNS server if the request was sent over a production virtual local area network (VLAN) in the first network.

18. The apparatus of claim 15, wherein the apparatus is further configured to evaluate content in the request to determine whether the request was sent on the quarantine VLAN.

19. The apparatus of claim 15, wherein the apparatus is provisioned in the first network.

20. The apparatus of claim 15, wherein the apparatus is provisioned in the second network.
